(19) United States
(12) Patent Application Publication
(10) Pub. No.: US 2024/0124669 A1
(43) Pub. Date: Apr. 18, 2024

(54) UV-CURABLE ETHYLENE SCAVENGING COMPOSITIONS

(71) Applicant: JOHNSON MATTHEY PUBLIC LIMITED COMPANY, London (GB)

(72) Inventor: Andrew CORNISH, Sonning Common (GB)

(21) Appl. No.: 18/264,872

(22) PCT Filed: Apr. 6, 2022
(86) PCT No.: PCT/GB2022/050861

§ 371 Date: Aug. 9, 2023

(30) Foreign Application Priority Data
Apr. 13, 2021 (GB) 2105224.6

(51) Int. Cl. C08J 7/18; A23B 7/01; A23B 7/152; C08G 77/14; C08J 7/04; C08K 3/34; C08K 5/55

(52) U.S. Cl. CPC C08J 7/18; A23B 7/012; A23B 7/152; C08G 77/14; C08J 7/0427; C08K 3/34; C08K 5/55; C08J 2483/06

(57) ABSTRACT

The invention relates to a UV-curable composition comprising: (i) a silicone comprising epoxy groups; (ii) an iodonium salt; and (iii) a metal-doped zeolite. A kit, from which the UV curable composition may be prepared and which also forms part of the invention, comprises: a first part comprising component (iii) dispersed in component (ii), and a second part comprising component (ii). The invention also relates to a method of preparing a material for the adsorption of ethylene by applying the UV curable composition onto a substrate and curing the material with UV light. The resulting cured materials also form part of the invention.

### FIELD OF THE INVENTION

The present invention relates to materials for the adsorption of ethylene from fruit, vegetables and other organic matter.

### BACKGROUND

The over-ripening or spoiling of fruit, vegetables and other organic matter during transit or storage can lead to significant produce loss and wastage. This is an increasing issue for those involved in fresh produce supply chains which may involve long transit times and variable climatic conditions. Modification of the atmosphere in which the organic matter is stored has been shown to be an effective strategy to prolong produce life. For example, alterations in oxygen and carbon dioxide levels within produce packaging can reduce produce respiration rates and therefore slow down the spoiling of fresh produce.

Other strategies involve the removal of volatile organic compounds (VOCs) from within, or surrounding, the produce packaging. VOCs are typically emitted by the produce itself, or may be present in the environment in which the produce is stored or transported. The presence of such VOCs can, for example, accelerate the spoiling of produce, lead to unwanted odours or tastes, or produce colour changes or other changes in appearance.

One such VOC is ethylene. Ethylene is a plant hormone and has a key role in many physiological processes in plants. For example, exogenous ethylene can initiate fruit ripening which in turn can lead to release of ethylene as the fruit ripens leading to high local concentrations. Other fresh produce types are also sensitive to ethylene even if their own ethylene production is low. The rate of ethylene generation can be a key factor in determining local ethylene concentrations, and this rate varies significantly between produce types. Excessive ethylene levels can lead to, for example, the premature ripening of fruit and vegetables, the wilting of fresh flowers, and the loss of green colour and an increase in bitterness of vegetables.

The control of ambient ethylene levels has been found to be effective in prolonging the shelf-life of many horticultural products, and various methods of ethylene control are utilised commercially. Methods include those based on ethylene adsorption and oxidation, for example the use of potassium permanganate.

Palladium-doped zeolites have been found to act as ethylene adsorbents. For example, it is described in WO2007/052074 (Johnson Matthey Public Limited Company) that palladium-doped ZSM-5 may be used to adsorb ethylene derived from organic matter.

Adsorbents used to remove ethylene are typically used in the form of a powder or as granules. In the case of use within a fresh produce package, the adsorbent material is typically contained within a sachet, pad or other insert located within the package.

It is also known to incorporate the adsorbent materials into packaging as an alternative to providing the adsorbent inside a sachet, pad or other type of insert.

WO2016/181132A1 (Innovia Films Ltd, Food Freshness Technology Holdings Ltd) describes a film for use in a packaging structure which comprises a coating on the film surface which comprises a binder and a particulate protuberent component able to remove VOCs. The examples utilise a palladium-doped zeolite with water-soluble acrylic copolymer or polyurethane binders. It is claimed that the protrusion of the particles can improve the efficiency of the removal of volatile organic compounds due to increased surface area of the scavenger to the environment. However, such protrusion may lead to problems with loss of the scavenging material and potential food contact, or exposure of the adsorbent material to water.

WO2019/175524 (Johnson Matthey PLC) describes a packaging structure comprising a base material with a coating on the surface of the base material, the coating comprising a silicone elastomer and an inorganic ethylene absorbent. The dispersion of an inorganic ethylene absorbent throughout the coating, rather than as particulates protruding from the film as in WO2016/181132, reduces the possibility of the adsorbent material contacting food or moisture. Several examples in WO2019/175524 use a palladium doped zeolite in a mixture of a vinyl terminated polydimethylsiloxane and a methylhydrosiloxane-dimethylsiloxane copolymer as a crosslinking agent. A platinum catalyst “C1098” of Pt(0) in tetramethyltetravinylcyclotetrailoxane (aka “Ashby's catalyst”) is used as a curing catalyst. The silicone mixture is applied as a layer on LDPE and cured thermally. In an alternative example Pt(acac)₂ is used as the catalyst in place of C1098 and the coated film cured at room temperature under natural light for a period of 5 days (see Example 4). The UV cured film showed ethylene scavenging ability comparable to the powdered scavenger.

UV curing of films is an attractive alternative to thermal curing for several reasons. Firstly, the energy demands of UV curing are lower than for thermal curing. Secondly, UV curing is compatible with a wider range of substrates as compared to thermal curing.

While the UV curable films described in WO2019/175524 show good ethylene scavenging ability, they exhibit a slow cure rate. This is problematic because it limits how quickly the film can be produced.

Subsequent (internal) trials by the present inventors showed that the cure time could be shortened by adding a more active curing catalyst in place of Pt(acac)₂. However, this requires careful handling of the curing catalyst is not ideally suited to scale-up.

There remains a need for ethylene scavenging materials which can be applied onto packaging and cured rapidly using UV, and which can be easily handled. The present invention addresses this problem.

### SUMMARY OF THE INVENTION

The present inventors have surprisingly found that mixtures of a silicone comprising epoxy groups, an iodonium salt and a metal-doped zeolite are UV curable and offer excellent ethylene scavenging ability, which solves the above problems.

Firstly, in contrast to the formulations described in WO2019/175524 which rely on an addition cure mechanism, a mixture of an epoxy-functional silicone, iodonium salt and metal doped zeolite shows low levels of background curing when mixed together. This means that the formulations offer a longer pot life.

Secondly, the compositions described herein exhibit a faster curing rate than either the thermally-cured or UV-cured compositions described in WO2019/175524. This is achieved without the need for a Pt-based curing catalyst which can be difficult to handle. Iodonium salts which act as the curing catalyst in the present invention are relatively easy to handle and do not require special containment provisions, unlike many Pt curing catalysts.

Before arriving at the present invention, the inventors trialled various different silicone compositions. Many were found to either not cure at a sufficiently fast rate when combined with an ethylene scavenger (Pd-doped zeolite), or did not demonstrate appreciable ethylene scavenging ability following curing.

Surprisingly, UV curable systems formed by combing silicones in the SILICOLEASE™ UV 200 series with SILICOLEASE™ UV CATA 243 (both available from Elkem Silicones) and a metal doped zeolite were found to exhibit long pot life, cure rapidly on exposure to UV, and showed an excellent ability to scavenge ethylene following curing. It is thought that this effect is a result of the combination of silicone and photoinitator used, namely a silicone comprising epoxy groups and an iodonium salt as the photoinitiator.

In a first aspect the invention provides a UV curable composition comprising:
(i) a silicone comprising epoxy groups;
(ii) an iodonium salt; and
(iii) a metal-doped zeolite.

As used herein, the term “UV curable composition” means a composition which can be cured in the presence of UV light to produce a composition which has the ability to scavenge ethylene from its surroundings.

In a second aspect the invention provides a kit comprising:
a first part comprising component (iii) dispersed in component (i); and
a second part comprising component (ii);

wherein components (i), (ii) and (iii) are as defined according to the first aspect.

The UV curable composition can be prepared by combining the first and second parts of the kit.

In a third aspect the invention provides a method for producing a material for the adsorption of ethylene, comprising the steps of:
(i) applying a UV-curable composition according to the first aspect onto a substrate; and
(ii) curing the UV-curable composition using UV light.

The method carries out curing using UV light and is less energy intensive than methods which rely on thermal curing.

In a fourth aspect the invention provides material for the adsorption of ethylene produced or producible by the method of the third aspect. The material comprises a substrate with a UV cured composition on a surface thereof. The material is suitable for adsorbing ethylene from the surrounding environment.

### DESCRIPTION OF THE DRAWINGS

FIG. 1 shows the results of an ethylene adsorption test using the coated films of Comparative Examples 1-2 and Examples 3-4

FIG. 2 shows the viscosity of the systems used in Examples 1-4 (before addition of catalyst) measured at 25° C. and sequential shear rates of 50 s⁻¹, 500 s⁻¹, 1000 s⁻¹ and 50 s⁻¹.

### DETAILED DESCRIPTION

Any sub-headings are included for convenience only and are not to be construed as limiting the disclosure in any way.

### UV Curable Composition

In a first aspect the invention provides a UV-curable composition comprising:
(i) a silicone comprising epoxy groups;
(ii) an iodonium salt; and
(iii) a metal-doped zeolite.
   Component (i)—Silicone Comprising Epoxy Groups

Component (i) is a silicone comprising epoxy groups, also referred to herein as an “epoxy silicone”. Typically, component (i) will be a copolymer comprising at least two different silicon-containing monomers, at least one of which comprises an epoxy group. It will be appreciated that silicones typically have a spread of chain lengths and therefore component (i) will typically comprise a mixture of different epoxy silicones.

The viscosity of component (i) has an important impact on the ability of the UV-curable composition to scavenge ethylene. A typical viscosity is 10-1000 mPa·s at 25° C., measured under a shear of 50 s⁻¹. A preferred viscosity is 10-500 mPa·s at 25° C., measured under a shear of 50 s⁻¹. A suitable and preferred method for measuring viscosity is reported in the Examples section.

Above a viscosity of 1000 mPa·s the epoxy silicone may be difficult to process. A viscosity as low as possible is beneficial because the lower the viscosity of component (i), the lower the viscosity of the UV curable composition as a whole. A low viscosity UV curable composition is desirable to allow a fast coating/printing speed.

It is preferred that component (i) has a viscosity of 10-100 mPa·s at 25° C., measured under a shear of 50 s⁻¹. Surprisingly, the use of an epoxy silicone having a viscosity in this range results in a composition having a higher ethylene scavenging rate compared to when using an epoxy silicone having a viscosity above 100 mPa·s. Such compositions may be particularly preferred where the packaging is to be used with produce that is particularly sensitive to high ethylene concentrations, since the high scavenging rate of the low viscosity epoxy silicone prevents build-up of ethylene in the packaging.

Exemplary epoxy silicones suitable for use as component (i) in the present invention are described as the “organosilicon component D” in US2015/232700A1, the disclosure of which is incorporated herein by reference. In particular, appropriate epoxy silicones are described at [0174]-[0213] of US2015/232700A1.

A particularly preferred class of epoxy silicones are those sold by Elkem Silicones under the brand SILCOLEASE™ UV POLY. Particularly preferred silicones include SILCOLEASE™ UV POLY 200 and SILCOLEASE™ UV POLY 204. These are recommended for use in combination with the photoinitiator SILCOLEASE™ UV CATA 243. In some embodiments component (i) may comprise a mixture of SILCOLEASE™ UV POLY 200 and SILCOLEASE™ UV POLY 204.

Component (ii)—Iodonium Salt

Component (ii) is an iodonium salt. The function of component (ii) is to initiate curing of the composition when exposed to UV light.

The term “iodonium salt” as used herein means a salt comprising an organic ion in which an iodine atom is bonded to two aryl rings.

Preferred iodonium salts are described in US2015/0232700A1, the disclosure of which is incorporated herein by reference. In particular, appropriate iodonium salts suitable for use in the present invention are defined in formula (I)′ of this reference, particularly paragraphs [0040]-[0052].

In preferred embodiments component (ii) is an iodonium salt of Formula (I)

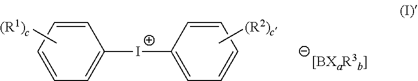

wherein each R1 and R2 are identical or different, and each represent a linear or branched alkyl radical having from 10 to 30 carbon atoms and preferably from 10 to 20 carbon atoms, even more preferably from 10 to 15 carbon atoms, even more preferably from 10 to 13 carbon atoms and even more preferentially 12 carbon atoms;
a and b are integers such that 0≤a≤3, 1≤b≤4 and a+b=4;
c and c′ are integers, which may be identical or different, ranging from 1 to 5;
each X, which may be identical or different, represent:
   a chlorine or fluorine atom with 0≤a≤3; or
   an OH function with 0≤a≤2, and
wherein each R3, which may be identical or different, represent a phenyl radical substituted with:
   at least 2 halogen atoms, and preferably with at least 2 fluorine atoms; or
   at least one electron-withdrawing group chosen from the group consisting of: —CF₃, —OCF₃, —NO₂, —CN, —SO₂CₙF₂ₙ₊₁, —(CO)CₙF₂ₙ₊₁, —OCₙF₂ₙ₊₁, and —CₙF₂ₙ₊₁, with n being an integer from 1 to 20; or
   an aryl radical containing at least two aromatic nuclei, such as biphenyl, naphthyl, optionally substituted with at least one halogen atom, in particular a fluorine atom,
or an electron-withdrawing group such as: —CF₃, —OCF₃, —NO₂, —CN, —SO₂CₙF₂ₙ₊₁, —(CO)CₙF₂ₙ₊₁, —OCₙF₂ₙ₊₁ and —CₙF₂ₙ₊₁, with n being an integer from 1 to 20.

It is preferred that c and c′ are equal to 1.

It is further preferred that c and c′ are both equal to 1, R1 is at the 4 position (para to the iodonium group) and R2 is at the 4′ position (para to the iodonium group).

It is further preferred that c and c′ are both equal to 1, R1 is at the 4 position (para to the iodonium group), R2 is at the 4′ position (para to the iodonium group) and both R1 and R2 are a C10-C13 alkyl groups.

It is preferred that b=4. In a particularly preferred embodiment b=4 and each R3 is a 2,3,4,5,6-pentafluorophenyl group, i.e. the counteranion is tetrakis(2,3,4,5,6-pentafluorophenyl)borate.

A particularly preferred iodonium salt is SILCOLEASE™ UV CATA 243 from Elkem Chemicals. This product is a mixture of iodonium salts in which the substituents R1 and R2 have a variety of different chain lengths. This product is described chemically as iodonium diphenyl-4,4′-di-C10-13-alkyl tetrakis(2,3,4,5,6-pentafluorophenyl)borates).

The weight ratio of component (i):component (ii) will readily be selected so as to achieve appropriate curing under UV. Typically the weight ratio of component (i):component (ii) is from 100:0.1 to 100:10, preferably from 100:0.1 to 100:5, more preferably from 100:0.1 to 100:2. These ratios achieve quick curing of the composition under UV.

Component (iii)—Metal-Doped Zeolite

Component (iii) is a metal-doped zeolite. The role of this component is to absorb ethylene.

For avoidance of doubt, the term “adsorbent” and “adsorption” as used herein should not be construed as being limited to the uptake of ethylene to a particular route and includes the chemical conversion of ethylene into secondary compounds. As used herein, the term “adsorbent” is synonymous with “absorbent”.

Zeolites may be classified by the number of T atoms, where T=Si or Al, that define the pore openings. Zeolites are referred to as small-pore (maximum pore size 8-membered ring), medium-pore (maximum pore size 10-membered ring) or large-pore (maximum pore size 12-membered ring). Preferably, in the current invention the zeolite has a small-pore or medium-pore framework, more preferably the zeolite has a small-pore framework. Zeolites with small- or medium sized pores have been found to retain a higher level of adsorbent capacity when combined with polymeric materials, in comparison to zeolites with large-pore frameworks, see WO2019/175524 (Johnson Matthey PLC).

Framework types may also be classified by the maximum diameter of a sphere that can diffuse along a channel of the zeolite framework. Preferably, the maximum diameter is greater than 3 Å, or more preferably greater than 3.5 Å, enabling rapid ethylene diffusion into the zeolite framework. It may be preferred that the maximum diameter is less than 5 Å, or less than 4 Å, in order to aid retention of adsorbent capacity when combined with the binder. Preferably, the maximum diameter of the framework type is between 3 Å and 5 Å, or preferably between 3.5 Å and 5 Å. Such data is provided for example in the Database of Zeolite Structures (Structure Commission of the International Zeolite Association, http://www.iza-structure.org/databases/).

Preferred zeolite framework types include medium-pore zeolites with an MFI framework type and small-pore zeolites with a AEI or CHA framework type. The three-letter codes used herein represent a framework type in accordance with the “IUPAC Commission on Zeolite Nomenclature” and/or the “Structure Commission of the International Zeolite Association”.

It is preferred that the framework type is selected from AEI or CHA, more preferably CHA. It will be understood that the zeolites may include regions in which the framework is a mixture or intergrowth, such as a CHA/AEI intergrowth, however it is generally preferred that the zeolite has a framework that is not an intergrowth of more than one framework type.

The zeolite typically has a silica to alumina molar ratio (SAR) of less than or equal to 100:1, such as between 10:1 and 50:1, preferably 10:1 to 40:1, more preferably 20:1 to 30:1.

The zeolite framework may be counterbalanced by cations, such as by cations of alkali and/or alkaline earth elements (e.g. Na, K, Mg, Ca, Sr, and Ba), ammonium cations and/or protons. Preferably, the zeolite is in the hydrogen form.

The zeolite is doped with a metal. Preferred metals are silver and palladium, preferably palladium. Preferred loadings of metal are 0.1 to 10 wt % based on the total weight of doped zeolite, preferably 0.2 to 2 wt %, more preferably 0.2 to 1.5 wt %. These loadings are particularly appropriate in the case of palladium.

Prior to incorporation into the UV-curable composition, the metal-doped zeolite is preferably in the form of particles, which typically have a volume distribution with a size (d50) of 1 μm to 25 μm, preferably 5 and 10 μm. The particle size distribution of particles may be measured, for example, by laser diffraction, for example by generating a suspension of particles in deionised water and measuring the particle size distribution using a Malvern™ Mastersizer™ 2000. It will be appreciated that the volume distribution of the metal-doped zeolite may change slightly following incorporation into the ink and following application of the ink onto a substrate, depending on the processing conditions used.

Such zeolites are typically prepared by incipient wetness impregnation using a palladium nitrate solution, drying the particles, and then calcining at a temperature between 450 and 750° C.

Typically, the UV curable composition comprises at least 1 wt % of component (iii) based on total weight of the UV curable composition. The maximum amount of component (iii) is not particularly limited in the present invention but typically the UV curable composition comprises less than 50 wt % of component (iii) based on the total weight of the UV curable composition. If the amount of component (iii) exceeds 50 wt % this can lead to difficulties with providing an even application of the coating. Typically, the UV curable composition comprises between 1 and 50 wt % of component (iii) based on the total weight of the UV curable composition, preferably between 10 and 50 wt %, such as between 20 and 40 wt %.

### Manufacturing the UV Curable Composition

The UV curable compositions are typically made by combining components (i)-(iii) at ambient temperature with mixing, for example using a magnetic stirrer. It is important to combine components (i) and (iii) before adding component (ii). This is so as to avoid premature curing of component (i) before the metal-based zeolite (iii) has been incorporated.

In a second aspect of the invention there is provided a kit comprising:
a first part comprising component (iii) dispersed in component (i); and
a second part comprising component (ii);
wherein components (i), (ii) and (iii) are as defined according to the first aspect.

It is preferred that the second part comprises component (ii) dissolved or dispersed in a solvent. Suitable solvents include alcoholic solvents, such as Guerbet alcohols as described in US2015/0232700.

The UV curable composition can be prepared by combining the first and second parts of the kit by mixing. Features described as being necessary or preferable for components (i), (ii) and (iii) in preceding sections also apply to the kit.

### Ethylene Absorbing Materials

The UV curable compositions can be used to manufacture materials for absorbing ethylene.

In a third aspect the invention provides a method for producing a material for the adsorption of ethylene, comprising the steps of:
(i) applying a UV-curable composition as described herein onto a substrate; and
(ii) curing the UV-curable composition using UV light.

The use of UV light to cure the composition rather than thermal methods has the advantage of lower energy costs.

The UV curable composition may be referred to herein as an “ink” as it may be applied on a substrate by printing. The UV curable composition may be applied onto the base material in step (i) using various printing methods known to those skilled in the art, for example by spray coating, roll coating, knife over roll coating, slot die coating, etc. In the case that the base material is a film, the coating step may advantageously be carried out using gravure roll coating, slot die or spray coating methods.

Depending on the coating method used, the UV-curable composition may be applied on the surface of the substrate in the form of a continuous coating (e.g. layer) or discontinuous coating. A discontinuous coating has the advantage that less UV curable composition may be required compared to a continuous coating. In addition, a discontinuous coating allows for the possibility of applying the composition as a design appealing to consumers, e.g. in the forms of shapes or logos.

The UV curable composition applied typically has a thickness of 5 to 200 μm, regardless of whether applied as a continuous or discontinuous coating.

The substrate is not particularly limited. Examples of suitable substrates include: a film, a bag, a container (e.g. a punnet), a lid for a container (e.g. the lid for a clamshell box), a packaging insert (e.g. a polymer strip).

The material of the substrate is not particularly limited. Typical substrates include polymer films commonly used in produce packaging, such as LDPEs. Another class of preferred substrate are fibrous polymers. For instance, a fibrous HDPE, of which Tyvek™ is a widely used and preferred example. Another preferred fibrous polymer is glassine.

In step (ii) the UV-curable composition is cured by exposure to a source of UV light to produce a cured composition on a surface of the substrate. UV conditions to cure the UV-curable composition will readily be determined by those skilled in the art.

The term “source of UV light” as used herein means a light source which includes light of wavelengths between 200-300 nm. The light source may also include light with wavelengths outside of this range. The source of UV light may be natural light, but this is a less preferred option because only a small proportion of natural light has UV wavelengths. It is preferred that the light source is a UV lamp, i.e. a light source which predominantly produced light with wavelengths of 200-300 nm. It is an advantage of the present invention that curing can be carried out at ambient temperature.

Typical conditions involve exposing the composition to a UV light source for a period of 0.1-10 seconds. This is a faster cure time than has been possible for previously described systems, and is advantageous because it allows for high productivity. Preferably the composition is exposed to a UV light source for a period of 0.1-5 seconds, such as 0.5-5 seconds.

In a fourth aspect of the invention there is provided a material for the adsorption of ethylene, produced by the method according to the third aspect. This material comprises a substrate with a UV cured composition on its surface. The UV-cured composition has the ability to scavenge ethylene from the surrounding environment.

The materials described herein may be advantageously used for the adsorption of ethylene, such as ethylene originating from organic matter, such as fruit, vegetables, cut flowers, or other foodstuffs. In particular, the materials may be used for the adsorption of ethylene originating from climacteric produce, such as bananas, avocados, nectarines, melons and pears which release a burst of ethylene during ripening, accompanied by an increase in respiration. Other non-climacteric produce types which are sensitive to ethylene include potatoes, onions, broccoli, cabbage and cut flowers.

Typically, the organic matter is contained in a packaging structure during storage and transportation, such as a crate, bag, bottle, box or punnet. The materials may therefore be advantageously used to control ethylene levels within such packaging structures.

The materials may be used to seal the packaging structure, for example to seal a punnet, bottle or a box, or may form the majority of the packaging structure, such as in the case of a bag, or may be used to wrap produce or wrap containers of produce, such as boxes or produce.

The packaging structure may comprise a packaging film that is perforated, for example with holes or slits which are typically 50-500 μm in diameter or length as appropriate. Such perforations may be formed by laser perforation. In use, the degree of perforation may be used to control the gaseous composition within the packaging structure once produce has been placed inside, leading to a lower oxygen content. Such a packaging structure may be known as modified atmosphere packaging. Both unmodified and modified atmosphere packaging structures may be used with packaging films as described herein.

### EXAMPLES

### Materials

SILCOLEASE™ UV POLY 200 (UV POLY 200), SILCOLEASE™ UV POLY 204 (UV POLY 204) and SILCOLEASE™ UV CATA 243 (UV CATA 243) were purchased from Elkem Silicones and used as received.

1% and 0.4% Palladium on chabazite (Pd-CHA) were prepared according to the procedure described in Example 1 of WO2019/175524.

(MeCp)PtMe₃ was supplied by Johnson Matthey PLC.

### Viscosity Measurement

Viscosity was measured using a Discovery™ HR3 Rheometer (TA Instruments). A parallel plate made of stainless steel of 25 mm diameter was used with a gap distance of 500 μm from the Peltier plate. The test sample was equilibrated at 25° C. for 60 s at rest. The viscosity was measured at the shear specified.

UV POLY 200 had a viscosity of 315 mPa·s measured at 25° C. and a shear of 50 s⁻¹.

UV POLY 204 had a viscosity of 44 mPa·s measured at 25° C. and a shear of 50 s⁻¹.

### Example 1 (Comparative)

This example is representative of the system described in Example 4 of WO2019/175524.

Vinyl terminated polydimethylsiloxane (DMS-V21, viscosity 100 cSt, wt. % vinyl: 0.8-1.2, Gelest Inc) (2 mL) and 1 wt % palladium-doped chabazite (0.4 g) were mixed in a speedmixer for 30 s at 1950 rpm. To this cross-linking agent (HMS-501, methylhydrosiloxane-dimethylsiloxane co-polymer, viscosity 10-15 mPa·s, 44-55 mol % MeHSiO, Gelest) (136 μL) and Pt(acac)₂ (20 uL, 0.0256 M in toluene) were added and the mixture stirred by hand for a minute.

1.2 g of the silicone elastomer composition was coated onto a glassine substrate using a k bar to provide a 70-100 μm thick coating. The coating was cured by passing under a UV light using a UV conveyor (Intertronics) with a mercury lamp with a line speed of 10 m/min. The residence time under the lamp was ˜2 seconds. Curing was incomplete after the first pass under the lamp. Five passes under the lamp were required to complete curing, corresponding to a cure time of 10 seconds. Curing was considered complete when no transfer of the coating took place when touched by a gloved hand.

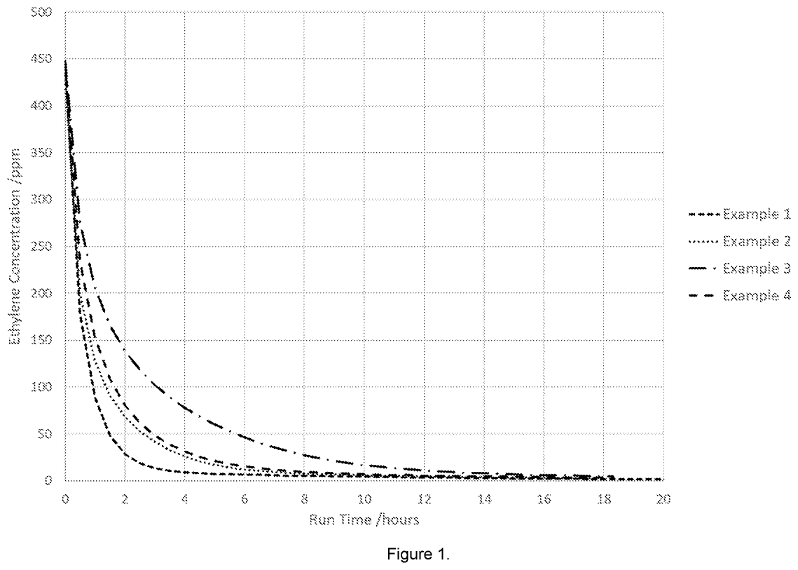

The coated film was tested for ethylene adsorption and the results are shown in FIG. 1.

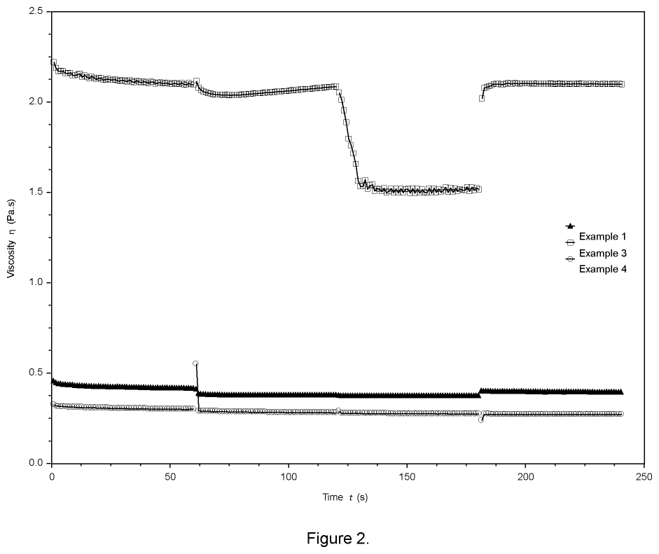

The viscosity of a formulation containing DMS-V21, HMS-501 and 1 wt % palladium-doped chabazite at the same mass ratio as used in Example 1, but without adding Pt(acac)₂ was measured and is shown in FIG. 2.

### Example 2 (Comparative)

This example corresponds to Example 1, except that the Pt(acac)₂ catalyst was replaced by a more active catalyst, namely (MeCp)PtMe₃.

Vinyl terminated polydimethylsiloxane (DMS-V21, viscosity 100 cSt, wt. % vinyl: 0.8-1.2, Gelest Inc) (3.75 g) and 0.4 wt % palladium-doped chabazite (1 g) were mixed in a speedmixer for 30 s at 1950 rpm. To this cross-linking agent (HMS-501, methylhydrosiloxane-dimethylsiloxane co-polymer, viscosity 10-15 mPa·s, 44-55 mol % MeHSiO, Gelest) (0.25 g) and (MeCp)PtMe₃ (8 uL, 0.063 M in toluene) were added and the mixture stirred by hand for a minute.

1 g of silicone elastomer composition was coated onto a glassine substrate using a Mayer bar to yield a coating thickness of 70-100 μm. The coating was cured by passing under a UV light using a UV conveyor (Intertronics) with a mercury lamp with a line speed of 10 m/min. The residence time under the lamp was ˜2 seconds. Curing was complete after 1 pass under the lamp.

The coated film was tested for ethylene adsorption and the results are shown in FIG. 1. While this example cured quicker than Example 1 and showed excellent ethylene scavenging performance, (MeCp)PtMe₃ requires special containment techniques.

The ratio of DMS-V21, HMS-501 and 1 wt % palladium-doped chabazite was the same as used in Example 1, and the viscosity of this mixture (before adding (MeCp)PtMe₃) was as shown in FIG. 2 for Example 1.

### Example 3

UV POLY 200 (6.5 g) was added to 0.4% Pd-CHA (3.5 g) with mixing. UV CATA 243 (73 mg) was added with further mixing. 1.0 g of the resulting mixture was coated onto a glassine substrate using a Mayer bar to provide a 70-100 μm thick coating. The coating was cured by passing under a UV light using a UV conveyor (Intertronics) with a mercury lamp with a line speed of 10 m/min. The residence time under the lamp was ˜2 seconds.

This example showed the same ethylene scavenging capacity as Comparative Examples 1 and 2, and the ethylene concentration was nearly 0 ppm after 12 hours. However, this system took longer to scavenge ethylene than either of Comparative Examples 1 or 2. This system can be cured rapidly with UV and, unlike Comparative Example 2, uses a UV initiator which is easy to handle.

The viscosity of a formulation containing UV POLY 200 and 0.4 wt % palladium-doped chabazite in the same mass ratio as used in Example 3 but without adding UV CATA 243 was measured and is shown in FIG. 2.

### Example 4

UV POLY 204 (6.5 g) was added to 0.4% Pd-CHA (3.5 g) with mixing. UV CATA 243 (73 mg) was added with further mixing. 1.0 g of the resulting mixture was coated onto a glassine substrate using a Mayer bar to provide a 70-100 μm thick coating. The coating was cured by passing under a UV light using a UV conveyor (Intertronics) with a mercury lamp with a line speed of 10 m/min. The residence time under the lamp was ˜2 seconds.

This example showed essentially the same ethylene scavenging capacity as Comparative Example 2. This system can be cured rapidly with UV and, unlike Comparative Example 2, uses a UV initiator which is easy to handle.

The viscosity of a formulation containing UV POLY 204 and 0.4 wt % palladium-doped chabazite in the same mass ratio as used in Example 4 but without adding UV CATA 243 was measured and is shown in FIG. 2. Example 4 had the advantage of being much less viscous than Example 3, which should allow for a faster coating speed.

1. A UV-curable composition comprising:
(i) a silicone comprising epoxy groups;
(ii) an iodonium salt; and
(iii) a metal-doped zeolite.

2. The UV-curable composition according to claim 1, wherein component (i) has a viscosity of 10-1000 m Pa·s at 25° C. and a shear of 50 s⁻¹.

3. The UV-curable composition according to claim 1, wherein component (i) has a viscosity of 10-100 m Pa·s at 25° C. and a shear of 50 s⁻¹.

4. The UV-curable composition according to claim 1, wherein component (ii) is an iodonium diphenyl-(4,4′-di-alkyl) tetrakis(2,3,4,5,6-pentafluorophenyl)borate, or a mixture thereof.

5. The UV-curable composition according to claim 4, wherein the alkyl group is a C10-13 alkyl group.

6. The UV-curable composition according to claim 1, wherein component (iii) is a metal-doped zeolite having the chabazite (CHA) framework.

7. The UV-curable composition according to claim 1, wherein component (iii) is a palladium-doped zeolite.

8. The kit comprising:
a first part comprising component (iii) dispersed in component (i); and a second part comprising component (ii);
wherein components (i), (ii) and (iii) are as defined claim 1.

9. A method for producing a material for the adsorption of ethylene, comprising the steps of:
(i) applying a UV-curable composition according to claim 1 onto a substrate; and
(ii) curing the UV-curable composition using UV light.

10. The method as claimed in claim 9, wherein the substrate is a polymer film.

11. The method as claimed in claim 9, wherein the substrate is a fibrous polymer.

12. The method as claimed in claim 9, wherein the substrate is a fibrous HOPE.

13. The method as claimed in claim 12, wherein the substrate is Tyvek™.

14. The method as claimed in claim 11, wherein the substrate is glassine.

15. The material for the adsorption of ethylene produced or producible by the method of claim 9.
